(19) United States
(12) Patent Application Publication
(10) Pub. No.: US 2003/0107528 A1
(43) Pub. Date: Jun. 12, 2003

(54) Immersion object detection device and wave reflector

(76) Inventors: Eiji Takemoto, Kyoto (JP); Tadao Nishiguchi, Kyoto (JP); Ryuji Kawamoto, Kyoto (JP)

Correspondence Address: DICKSTEIN SHAPIRO MORIN & OSHINSKY LLP, 2101 L STREET NW, WASHINGTON, DC, 20037-1526, US

(21) Appl. No.: 10/285,489

(22) Filed: Nov. 1, 2002

(30) Foreign Application Priority Data
Nov. 2, 2001 (JP) 2001-338325

(51) Int. Cl. H01Q 15/14

(52) U.S. Cl. 343/912

(57) ABSTRACT

A transmitter-receiver antenna of a radar is prepared as a parabolic antenna, and a wave reflector is constituted by a reflector array having a plurality of reflectors, and multiple beam widths of a transmission wave in the vicinity of the radar and a reflected wave in the vicinity of the electric wave reflector are set to be greater than a beam width C that can be blocked by a non-detection subject, such as a bird, that is excluded from detection subjects. Thus, it becomes possible to improve the identifying precision between the detection subject and the non-detection subject, and consequently to provide an immersion object detection device with high reliability that can reduce erroneous detections.

### FIELD OF THE INVENTION

The present invention relates to an immersion object detection device for detecting any immersion object in a detection area by receiving reflected waves of released electric waves, and also concerns a wave reflector that is preferably used for an immersion object detection device and the like.

### BACKGROUND OF THE INVENTION

Conventionally, with respect to crime prevention sensors for detecting trespassers and immersion objects, various types of sensors such as infrared sensors, ultrasonic sensors and electric-wave radar devices have been proposed. Electric-wave radar devices utilizing electric waves, which are less susceptible to natural environmental variations such as rain, snow, wind and dust, have drawn attention as immersion object detection devices which have highly reliable detection characteristics, even when used outdoors.

With respect to the electric-wave radar devices of this type, for example, a device as shown in FIG. 18 has been proposed. This radar 100 is provided with an antenna 103 for transmitting and receiving electric waves. The radar 100 releases a transmission wave 105 from the antenna 103 in a predetermined direction and the wave reflected by an object that has blocked the beam is received by the antenna 103 so that the presence or absence of an immersion object is detected by observing the intensity of the received electric power.

In general, with respect to the immersion object detection device, detection subjects that are to be detected and non-detection subjects that are to be excluded from the detection subjects are preliminarily clarified in most cases. For example, in the case of crime-prevention-use immersion object detection devices, detection subjects are limited to human beings (in particular, adults) that are trespassers and the other objects such as small animals like birds and dogs and flying objects such as balls are non-detection subjects. Improvements in immersion object detection device capabilities in distinguishing between the detection subjects and non-detection subjects, or identifying precision, have been sought in order to improve the reliability of the immersion object detection device by eliminating erroneous detection (erroneously detecting a non-detection subject as a detection subject).

Here, in the above-mentioned conventional immersion object detection device, a transmission wave 105, released from the radar 100, is transmitted while expanding in accordance with the directivity of the antenna 103 as it is departing from the radar 100. Therefore, at a position which is sufficiently separated from the radar 100, the beam width (beam diameter) is allowed to have a sufficient expansion with respect to a non-detection subject such as a bird 109.

When a bird 109 or the like passes through the vicinity of the area, all the beam is not blocked with only one portion of the beam being reflected, the intensity of received electric power to be observed by the radar 100 is small; in contrast, in the case when a trespasser 108 passes through the area, since almost all the beam is reflected, the intensity of received power becomes greater. Based upon these facts, the identification between the trespasser 108 and the bird 109 can be made comparatively easily.

However, in the vicinity of the radar 100, since a beam width A100 is narrow, most of the beam is blocked and reflected, even when an object such as a bird 109 that is smaller than a human being passes through the area; therefore, the received electric powers of the radar 100 virtually have no difference between the bird 109 and the trespasser 108.

Therefore, in the device having the conventional structure, it is very difficult to identify the detection subject from non-detection subjects in the vicinity of the radar 100, and this results in a serious problem of an erroneous detection of a bird or the like as a trespasser.

In order to solve this problem, an arrangement has been proposed in which an antenna is designed to make planes of polarization of a transmission wave and a received wave virtually orthogonal to each other so that a primary reflected wave from a small object, such as an insect passing through the vicinity of the antenna, is not received with only a secondary reflected wave from a big object, such as a human being, passing through a distant area being mainly received so as to reduce erroneous detections.

This method certainly makes it possible to prevent an erroneous detection in the case of an insect that is sufficiently small in comparison with the wavelength of a transmission wave, since it does not cause a change in the plane of polarization in the primary reflection. However, in the case of a small animal such as a bird that has a considerably large size in comparison with the wavelength, the plane of polarization tends to vary even in the primary reflection, and a secondary reflection is generated in the same manner as a human being; consequently, the above-mentioned method fails to prevent erroneous detections. Further, in the vicinity of the radar, there is no difference in the states of beam blocking and reflection between cases of a human being and a bird; therefore, it is impossible to clearly identify these two objects.

Moreover, in this method, since a secondary reflected wave that has been reflected not less than two times repeatedly is mainly received, the received wave fails to exhibit clear peaks with a smaller received electric power; therefore, it becomes difficult to improve the detection precision as a whole. Furthermore, since this method is formed on the assumption of reflections from the ground, it is necessary to direct a beam toward the ground, with the result that the detection area is limited to a narrow range.

### BRIEF SUMMARY OF THE INVENTION

The present invention has been devised to solve the above-mentioned problems, and its objective is to provide an immersion object detection device with high reliability, which can improve the identifying precision between a detection subject and a non-detection subject, and reduce erroneous detections.

Moreover, another objective is to provide a wave reflector that is suitable for the device of this type.

In order to achieve the above-mentioned objectives, one aspect of the present invention is directed to an immersion object detection device which is provided with a radar having a transmitter-receiver means for transmitting and receiving electric waves and a reflection means which reflects an electric wave transmitted from the radar toward the same radar so that an immersion object entering a detection area formed by electric-wave beams that are carried between the radar and the reflection means is detected, and in this device, the beam cross-sectional areas of a transmission wave in the vicinity of the above-mentioned radar and a reflected wave in the vicinity of the above-mentioned reflection means are set to be greater than a beam cross-sectional area that can be blocked by a predetermined non-detection subject that is excluded from detection subjects.

In accordance with this invention, even when a non-detection subject passes through the detection area in the vicinity of the radar or in the vicinity of the reflection means, the non-detection subject does not block all the beam. Therefore, it is possible to provide a clear difference in the received electric power received by the radar between cases in which a detection subject blocks the beam and in which a non-detection subject blocks the beam, and consequently to clearly identify these two subjects.

Moreover, with respect to the layout of the radar and the reflection means, an arrangement in which the two elements are aligned face to face with each other with a straight-line-shaped detection area is proposed as the simplest arrangement, or another arrangement may be proposed in which a bending member for bending the advancing path of the beam is placed between the radar and the reflection means so that the detection area may be set to have a non-straight-line shape. Alternatively, the advancing path of the beam may be bent by using a single or a plurality of bending members, and relayed so that the detection area may be designed to have, for example, an arrow point shape, a U-letter shape or a box shape. Here, the bending refers to bending the advancing direction of electric waves by utilizing functions such as reflection, refraction and diffraction. With respect to the bending member, for example, a device such as a plane reflective plate may be preferably used.

With respect to the installation position, since electric waves are utilized in the present invention, the present invention is less susceptible to natural environmental variations such as rain, snow, wind and dust, and preferably used even in an installation environment such as outdoors. In particular, even when the electric wave emitting portion of the radar, the reflecting portion of the reflection means and the bending members are stained by dust and sand grains, the present invention hardly has adverse effects such as attenuation of the beam intensity and irregular reflection, and provides superior environmental resistance, reliability and convenience, in comparison with immersion object detection devices using infrared rays and light.

With respect to how great a degree the beam cross-sectional areas of the transmission wave in the vicinity of the radar and the reflection waves in the vicinity of the reflection means needs to be increased in comparison with the beam cross-sectional area that can be blocked by a non-detection subject, it is different depending on the applications of the present invention. For example, the beam cross-sectional areas of the above-mentioned transmission wave and reflected wave are set to a degree which allows the difference between the sizes of the detection subject and the non-detection subject, that is, difference between the beam cross-sectional area which can be blocked by the detection subject and the beam cross-sectional area which can be blocked by the non-detection subject, to become sufficiently recognizable as a difference in the radar receiving electric powers. Moreover, since electric waves have longer wavelengths in comparison with light, one portion of the applied electric wave sometimes passes through the object depending on the material and thickness of the object. Therefore, when the material, thickness and transmittance of each of the detection subject and the non-detection subject have been predetermined, it is preferable to set the beam cross-sectional areas of the above-mentioned transmission wave and reflected wave by talking these conditions into consideration.

Moreover, in another aspect of the present invention, the beam cross-sectional areas of the transmission wave in the vicinity of the radar and the reflected wave in the vicinity of the reflection means may be designed to expand in at least one direction with respect to the greatest beam cross-sectional area that can be blocked by the above-mentioned non-detection subject.

In the case when the beam cross-sectional areas of the transmission wave and the reflected wave are allowed to expand in at least in one direction in this manner, it is possible to prevent the non-detection subject from blocking all the beam, and consequently to provide a clear difference in the received electric power received by the radar and the subsequent clear identification of the two objects. Furthermore, with an arrangement in which the beam cross-sectional areas of the transmission wave and the reflected wave are allowed to expand in multiple directions or all directions, the identifying property of the two objects is further improved. However, since the expansion of the beam cross-section also makes the radar and the reflection means become bulky, the expanding direction of the beam cross section is preferably determined by taking the balance between the installation condition of the present device and the identifying characteristics of the two objects into consideration. For example, in the case when the upper limit of the horizontal direction (width direction) of the radar and the reflection means are determined as the setting conditions, the beam cross-section may be expanded in the vertical direction (height direction), and in the case when the setting is opposite to the above-mentioned case, the beam cross-section may be expanded in the horizontal direction.

The above-mentioned transmitter-receiver means may be constituted by a transmission means for transmitting electric waves and a receiving means for receiving electric waves that are installed in a separate manner, or may be constituted by a single part that commonly has a transmitting function and a receiving function.

In another aspect for expanding the beam cross-section in the vicinity of the radar, it is preferable to use an arrangement in which an opening face antenna having an aperture area greater than the beam cross-sectional area that can be blocked by the above-mentioned non-detection subject is adopted as the transmitter-receiver means.

The opening face antenna refers to an antenna which radiates electric waves from a face in the form of an opening, and this antenna makes it possible to provide wide parallel beams in the beam cross-section (beam width), and consequently to obtain plane waves with a high gain easily.

In one aspect of the reflection means, the above-mentioned reflection means is prepared as a reflector array constituted by a plurality of reflectors that are placed with aligned opening faces, and it is preferable to use an arrangement in which the aperture area of the entire reflector array is set to be greater than the beam cross-sectional area that can be blocked by the above-mentioned non-detection subject.

Here, the reflector refers to a member that is constituted by, at least, a reflection unit for reflecting electric waves and an opening face from which the electric waves reflected by the reflection unit are radiated as plane waves. This opening face may be a face that physically appears, or may be a face that is defined hypothetically as a plane that allows the reflected waves to have the same phase.

With this arrangement, although the beam width of each of the reflected waves from the reflector is small, the entire reflector array provides a beam width that is greater than the beam cross-section that can be blocked by the non-detection subject; therefore, it is possible to ensure sufficient identifying precision of the non-detection subject in the vicinity of the reflection means. Moreover, since the shape of the reflector array can be freely set depending on how to select the layout of the reflector, it is possible to easily achieve such a structure as to expand the beam cross-section of the reflected waves in one direction or in multiple directions as described above. This arrangement is particularly advantageous when the size of the reflection means is limited due to the limitation of the installation place or the like.

Here, with respect to a layout mode of the opening faces of the reflectors, an arrangement in which all the opening faces of the reflectors are aligned on the same plane is the simplest. This arrangement is advantageous from the point of view of easy manufacturing processes.

Moreover, in another layout mode, an arrangement in which the respective opening faces of a plurality of reflectors are placed in a manner so as to align over the same phase plane of electric waves may be preferably adopted.

In the case of a reflector array constituted by aligning a plurality of reflectors, the reflectors placed in the vicinity of the beam axis and those placed far away from the beam axis have a slight difference in the distance from the electric wave radiation source of the radar. When the difference is such a small degree that it is negligible in comparison with the wavelength of electric waves, even the above-mentioned structure in which the opening faces are aligned on the same plane causes no problems. However, in the case when the difference is large, a deviation occurs in the phases of the reflected waves of the respective reflectors, interference in electric waves sometimes occurs. Therefore, by making the opening face of each reflector virtually coincident with the same phase face of the electric wave, it becomes possible to prevent the occurrence of a deviation in the phases of the reflected waves and to improve the reflection efficiency of the reflector so as to ensure sufficient identifying precision of the non-detection subject in the vicinity of the reflection means by increasing the reflection efficiency of the reflector.

Furthermore, in another aspect of the reflection means, the above-mentioned reflection means is preferably designed as a reflector that has an aperture area that is greater than a beam cross-sectional area that can be blocked by the above-mentioned non-detection subject.

In accordance with this arrangement, different from the reflector array, it is not necessary to prepare a method for preventing the phase deviation between reflectors, and it becomes possible to provide very easy manufacturing processes. This simple structure also makes it possible to ensure sufficient identifying precision of the non-detection subject in the vicinity of the reflection means.

With respect to the shape of such a reflector, various shapes are proposed, and among those shapes, the reflector is preferably designed to a cone shape or a truncated cone shape, with the side face forming a reflection face and the bottom face forming an opening face, with at least one corner portion including the bottom face having a cutout shape. More preferably, the above-mentioned reflector has a pyramid shape or a truncated pyramid shape with three reflection faces that are respectively orthogonal to each other.

As described above, there are many cases in which the size of the reflection means is limited due to the limitation of the installation position or the like; however, since the corner portion including the bottom face is cut out, it is possible to miniaturize the outer shape of the reflector while the aperture area of the reflector is maintained. Moreover, in the case when the shape of the truncated cone shape is adopted, since the apex portion is flattened, it becomes possible to further miniaturize the size, in comparison with the cone shape.

Moreover, from another aspect of the structure of the present invention, an immersion object detection device of the present invention is provided with a radar having a transmitter-receiver means for transmitting and receiving electric waves and a reflection means which reflects an electric wave transmitted from the radar toward the same radar so that an immersion object entering a detection area formed by electric-wave beams that are carried between the radar and the reflection means is detected, and this device is further provided with a transmission wave expanding means which expands the beam cross-sectional area of a transmission wave in the vicinity of the above-mentioned radar so as to become greater than a beam cross-sectional area that can be blocked by a predetermined non-detection subject that is excluded from detection subjects. Moreover, this device is further provided with a reflected wave expanding means which expands the beam cross-sectional area of a reflected wave from the reflection means so as to become greater than a beam cross-sectional area that can be blocked by a predetermined non-detection subject that is excluded from detection subjects.

Moreover, the above-mentioned structures have been discussed as the structure relating to an immersion object detection device of a regression reflection type; however, among the above-mentioned structures, the structure relating to the radar may be preferably applied to an immersion object detection device of a direct reflection type. In other words, the immersion object detection device of a direct reflection type of the present invention is also directed to an immersion object detection device which is provided with a radar having a transmitter-receiver means for transmitting and receiving electric waves so that an immersion object is detected by receiving reflected waves from the immersion object, and in this device, the beam cross-sectional area of a transmission wave in the vicinity of the above-mentioned radar is set to be greater than a beam cross-sectional area that can be blocked by a predetermined non-detection subject that is excluded from detection subjects. In this case also, the above-mentioned opening face antenna is preferably used as the transmitter-receiver means.

With respect to a supporting member for supporting the transmitter-receiver means or the reflection means in the above-mentioned structure, it is preferably provided with a fixing unit on which the transmitter-receiver means or the reflection means is secured and a parallel moving mechanism which is capable of moving the fixing unit in parallel with the supporting member installation face when the supporting unit is tilted.

In accordance with this structure, even when the supporting unit is tilted by any impact from the external environment, such as wind, rain or flying objects, the fixing unit and the supporting unit installation face are maintained in parallel with each other; therefore, the transmitter-receiver means and the reflection means are less susceptible to influences from the tilted supporting member. Thus, the advancing direction of the beam released from the transmitter-receiver means and the relative angle between the reflection means opening face and the beam are always maintained in a fixed state, and it becomes possible to preliminarily prevent degradation in the received electric power due to deviations in the beam axis and degradation in the identifying precision.

Moreover, the present invention is preferably provided with a radome that covers the above-mentioned transmitter-receiver means or reflection means and the above-mentioned supporting member, and the above-mentioned supporting member is preferably connected to the radome through an elastic member.

With this structure, the elastic member has a function for serving as an impact-absorbing means for alleviating an impact from the external environment, and even when the supporting member is tilted, the tilt of the supporting member is corrected by an elastic recovering force of the elastic member; thus, it is possible to further prevent degradation in the receiving electric power due to deviations in the beam axis and degradation in the identifying precision.

Moreover, the above-mentioned respective structures of the reflection means may be considered as an invention of a wave reflector in an independent manner. This wave reflector makes it possible to exert the above-mentioned functions and effects, and is preferably used as the reflection means for an immersion object detection device; however, not limited to the immersion object detection device in its range of application, it may be generally applied to an electric-wave radar device.

The above and other features and advantages of the invention will be more readily understood from the following detailed description which is provided in connection with the accompanying drawings.

### BRIEF DESCRIPTION OF THE DRAWINGS

FIG. 1 shows a schematic drawing that indicates the entire structure of an immersion object detection device in accordance with a first embodiment of the present invention.

FIG. 2A shows a perspective view that indicates one portion of a reflector array in accordance with the first embodiment, and FIG. 2B shows a perspective view that indicates the shape of a reflector that is a constituent element of the reflector array.

FIG. 3 shows a schematic drawing that shows a structure of the reflector array, FIG. 3A is a front view and FIG. 3B is a cross-sectional view taken along line B-B of FIG. 3A.

FIG. 4 shows a functional block diagram that indicates a structure of a radar in accordance with the first embodiment.

FIG. 5 shows a graph that indicates one example of spectrum data with the frequency being plotted on the axis of abscissa and the intensity of received electric power being plotted on the axis of ordinate.

FIG. 6 shows a flow chart that indicates a flow of determining processes which determines whether or not a detected object is a detection subject.

FIG. 7 shows a graph that indicates one example of spectrum data with time being plotted on the axis of abscissa and the intensity of received power being plotted on the axis of ordinate, FIG. 7A shows one example of data of a regression reflection wave, and FIG. 7B shows one example of data of a direct reflection wave.

FIG. 8 shows a schematic drawing that indicates a structure of a radar in accordance with a second embodiment of the present invention.

FIG. 9 shows a cross-sectional view that indicates a reflector array in accordance with a third embodiment of the present invention.

FIG. 10 shows a schematic drawing that indicates the entire structure of an immersion object detection device in accordance with a fourth embodiment of the present invention.

FIG. 11 shows a schematic drawing that indicates a structure of a reflector in accordance with the fourth embodiment, FIG. 11 A shows a front view, and

FIG. 11B shows a side view.

FIG. 12 shows a schematic drawing that indicates a modified example of the reflector, FIG. 12A shows a front view, and FIG. 12B shows a side view.

FIG. 13 shows a schematic drawing that indicates a modified example of the reflector, FIG. 13A shows a front view, and FIG. 13B shows a side view.

FIG. 14 shows a schematic drawing that indicates a modified example of the reflector, FIG. 14A shows a front view, and FIG. 14B shows a side view.

FIG. 15 shows a schematic drawing that indicates a structure of a wave reflector in accordance with a fifth embodiment of the present invention.

FIG. 16 shows a schematic drawing that indicates a modified example of the wave reflector.

FIG. 17 shows a schematic drawing that indicates another structural example of an immersion object detection device in accordance with the embodiments of the present invention.

FIG. 18 shows a schematic drawing that indicates the entire structure of a conventional immersion object detection device.

### DETAILED DESCRIPTION OF THE INVENTION

Referring to Figures, the following description will discuss preferred embodiments of the present invention in detail. Here, for example, the present invention is applied to an immersion object detection device for crime prevention. In this case, it is assumed that a detection subject to be detected by the immersion object detection device is a human being (in particular, adult) and that non-detection subjects that are excluded from detection subjects are small animals, such as birds or dogs, or flying objects such as balls.

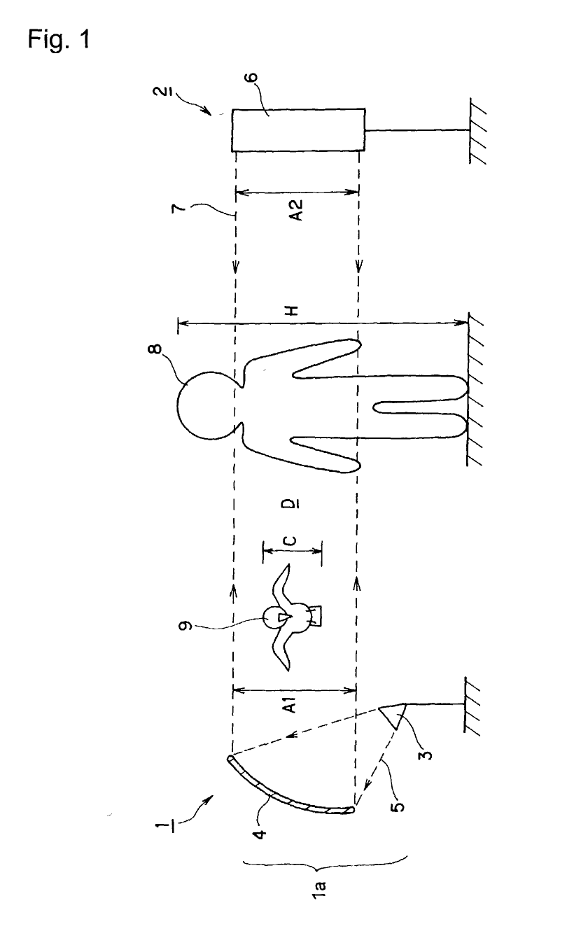

Referring to FIGS. 1 to 7, the following description will discuss an immersion object detection device in accordance with a first embodiment. FIG. 1 shows a schematic drawing that indicates the entire structure of an immersion object detection device in accordance with the present embodiment. As shown in this Figure, this immersion object detection device is a so-called regression reflection type radar device, which is constituted by a radar 1 and a wave reflector 2 that is placed face to face with the radar 1.

The radar 1 is provided with a transmitter-receiver antenna 1a that serves as a transmitter-receiver means for transmitting and receiving electric waves. The transmitter-receiver antenna 1a is designed as an offset parabola antenna that is one form of an opening face antenna, and provided with a primary radiating source 3 of electric waves and a reflection mirror 4. This reflection mirror 4 is provided with a reflection face that is formed by a rotation parabolic face, and its shape is determined based upon the frequency of electric waves that are radiated from the primary radiating source 3. Moreover, the opening face of the reflection mirror 4 is provided with an aperture area that is sufficiently greater than a bird 9 that is a non-detection subject. In other words, the transmitter-receiver antenna 1a has an aperture area that is greater than a beam cross-sectional area that can be blocked by the non-detection subject.

Upon transmitting an electric wave, a transmission wave (electric wave), which is radiated toward the reflection mirror 4 from the primary radiating source 3, is reflected by the reflection mirror 4, and radiated as a plane wave having an aligned phase on its opening face. This transmission wave 5, which forms a plane wave, has a comparatively sharp directivity, and forms parallel beams that have little expansion. This transmission wave 5 is allowed to have a beam width A1 in the vertical direction that is smaller than the height H of a human being 8 that is a detection subject, and is also sufficiently greater than the height C of a bird 9 that is a non-detection subject in the vicinity of the radar 1.

Moreover, upon receiving an electric wave, the reflected wave 7 reflected by the wave reflector 2 is reflected and converged by the reflection mirror 4, and received by the primary radiating source 3.

The wave reflector 2 is constituted by a reflector array 6 serving as a reflection means for reflecting a transmission wave 5 transmitted by the radar 1 toward the same radar 1. The reflector array 6 is constituted by a plurality of reflectors that have a characteristic for reflecting an incident electric wave in a direction virtually opposite to the incident direction, and this characteristic is also maintained in the reflector array 6 as a whole. .

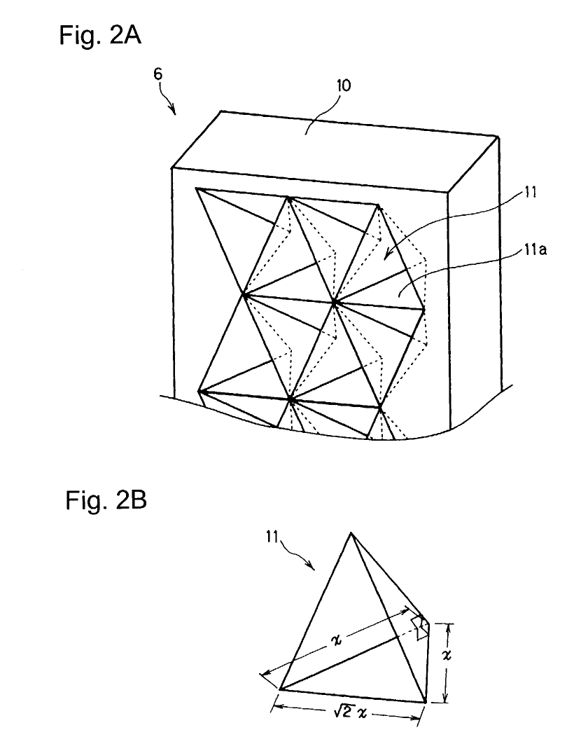

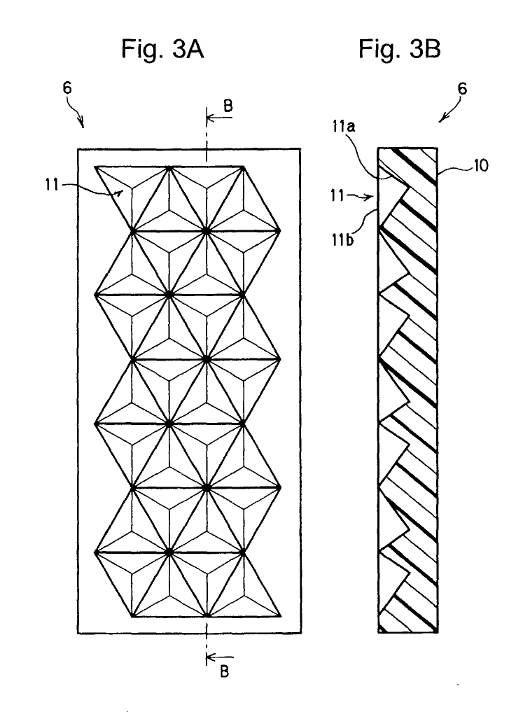

FIGS. 2 and 3 show the structure of the reflector array 6 of the present embodiment. FIG. 2A shows a perspective view that indicates one portion of the reflector array 6, and FIG. 2B shows a perspective view that indicates the shape of a reflector 11 that is a constituent element of the reflector array 6. FIG. 3A shows a front view of the reflector array 6, and FIG. 3B shows a cross-sectional view taken along line B-B that indicates the reflector array 6.

As shown in FIGS. 2 and 3, the reflector array 6 is constituted by an aggregate of a plurality of reflectors 11 that have a comparatively small size, and are placed with opening faces 11b being aligned. This reflector array 6 is manufactured by, for example, machining the surface of a base member 10 made of resin so as to form a plurality of recessed portions having a pyramid shape and vapor-depositing metal such as A1 on the surfaces of the recessed portions.

Each reflector 11 has a pyramid shape having three reflection faces 11a that are orthogonal to each other, and the portion corresponding to the bottom face forms an opening face 11b. The respective reflection faces 11a have a shape of a right angled isosceles triangle and are mutually congruent, with the opening face 11b forming a right triangle shape. Here, the shape of the reflector is not limited by this shape, and those having various shapes, such as a square shape and a hexagonal shape, in the opening face thereof may be adopted.

In most cases, the wave reflector 2 is housed in a longitudinal radome having a cylindrical shape so as to improve the outdoor weatherability, and is limited in its external size. However, the above-mentioned arrangement in which a plurality of comparatively small reflectors 11 are placed makes it possible to miniaturize the wave reflector 2 with an optimal aperture area being maintained by appropriately selecting the layout of the reflectors 11.

In the present embodiment, assuming that the wave reflector 2 is housed in the longitudinal radome, a longitudinal reflector array 6, which has 28 reflectors 11 that are aligned in 4 rows in the horizontal direction and in 7 columns in the vertical direction, is used. In other words, with respect to the width in the horizontal direction, it is set to a comparatively small size due to the limitation in the installation position, and with respect to the width in the vertical direction, it is set so that the aperture area of the entire reflector array 6 becomes greater than the beam cross-sectional area that can be blocked by the non-detection subject.

As shown in FIG. 1, when the reflector array 6 having such an arrangement is used, the reflected wave (electric wave) 7, reflected by the reflector array 6, is radiated as a plane wave having an aligned phase on its opening face, and forms parallel beams virtually in the same manner as the transmission wave 5. The reflected wave 7 is already allowed to have a beam width A2 that is smaller than the height H of a human being 8 that is a detection subject and is also sufficiently larger than the height C of a bird 9 that is a non-detection subject, in the vicinity of the wave reflector 2.

In this manner, in the present device, a detection area D (also referred to as a warning line) is formed by parallel beams between the radar 1 and the wave reflector 2. The detection area D covers the entire area from the opening face of the transmitter-receiver antenna 1a of the radar 1 to the opening face of the reflector array 6 of the wave reflector 2 so that it has a width wider than the greatest beam cross-section that can be blocked by a non-detection subject such as an animal like a bird 9 and a ball at least in the vertical direction. Therefore, it is possible to carry out an immersion object detecting process even in the vicinity of the radar 1 or the wave reflector 2 with the same precision as that in the middle of the detection area D.

In FIG. 1, the human being and the other small objects can be discriminated from each other; however, the present invention is not intended to be limited by this object, and may be used as a sensor which can discriminate, for example, a subject having a size exceeding a predetermined size from the other objects having a size no more than the predetermined size so as to detect objects out of a standard size.

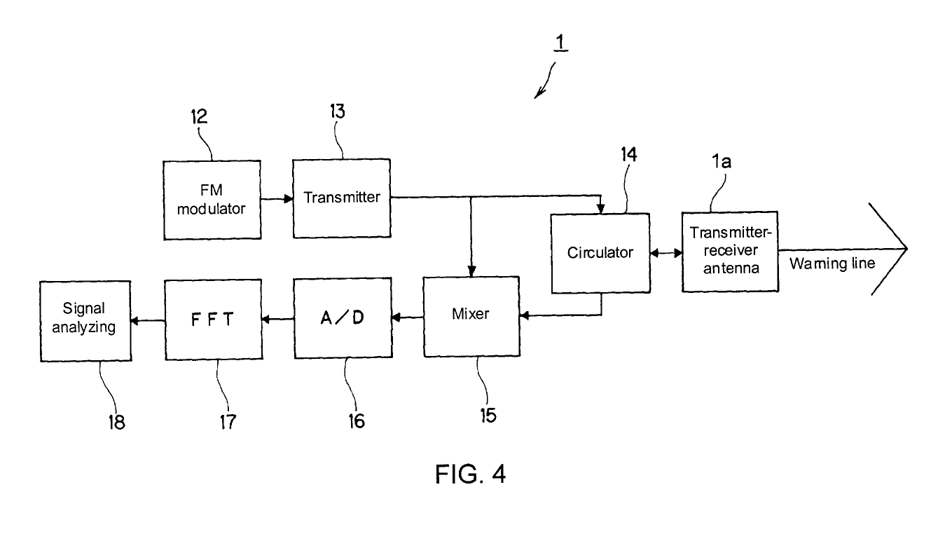

Next, referring to FIG. 4, the following description will discuss an inner structure of the radar 1 in detail. FIG. 4 shows a functional block diagram that indicates the structure of the radar 1.

The radar 1 forms a myriametric wave radar of a FM-CW system (FM-continuous wave method), and as shown in this Figure, is constituted by a transmitter-receiver antenna 1a, an FM modulator 12, a transmitter 13, a circulator 14, a mixer 15, an A/D converter 16, an FFT processing unit 17 and a signal analyzing unit 18. The FM-CW system refers to a system which transmits a continuous wave modulated by FM, and detects the presence of an object and the distance from the object based upon the phase difference between the transmitted wave and the reflected wave.

The FM modulator 12 is a block which controls the frequency of a transmission wave signal generated in the transmitter 13. The FM modulator 12 generates a control signal in a manner so as to make the transmission frequency vary linearly with a predetermined frequency deviation centered on a reference frequency, and outputs the resulting signal to the transmitter 13. In the present embodiment, the reference frequency is set to 76 GHz, the maximum frequency deviation is set to ±100 MHz, and the wavelength of the electric wave is set to approximately 4 mm.

The transmitter 13 is a block that modulates a transmission wave signal based upon a control signal inputted from the FM modulator 12. The transmission signal, thus modulated, is inputted to the circulator 14 and the mixer 15.

The circulator 14 is a device which separates the signals of the transmission wave and the receiving wave. The circulator 14 has three terminals, and these are respectively connected to the transmitter 13, the transmitter-receiver antenna 1a and the mixer 15. Among the three terminals of the circulator 14, the input and output directions are determined in a circulating manner, and the transmission wave signal inputted from the transmitter 13 is outputted to the transmitter-receiver antenna 1a, and the receiving wave signal inputted from the transmitter-receiver antenna 1a is outputted to the mixer 15.

The mixer 15 is a frequency mixer which generates a beat signal based upon the phase difference between the frequency of the transmission wave signal inputted from the transmitter 13 and the frequency of the receiving wave signal inputted from the circulator 14.

The A/D converter 16 is a device which converts the beat signal obtained from the mixer 15 to a digital signal.

The FFT processing unit 17 is a block which carries out an FFT (fast fourier transform) process on the beat signal that has been generated by the mixer 15, and converted to the digital signal by the A/D converter 16. The beat signal, which has been subjected to the FFT process, is spectrum-converted, and converted to spectrum data represented by parameters of the frequency and received electric power intensity.

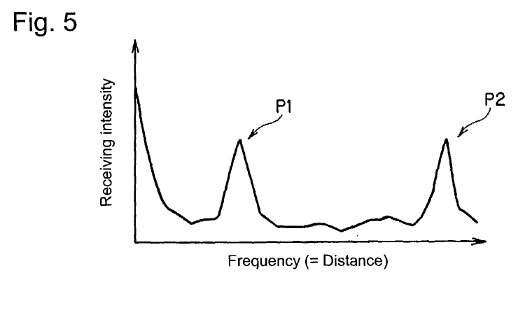

FIG. 5 shows a graph that indicates one example of spectrum data with the frequency being plotted on the axis of abscissa and the intensity of received electric power being plotted on the axis of ordinate. In this graph, the peaks indicate reflected waves from any objects, and the frequencies of the peaks indicate distances from the radar 1 to the respective objects. In this graph, peak P1 corresponds to a direct reflected wave from an immersion object into the detection area, and peak P2 corresponds to a regression reflected wave from the wave reflector 2. The frequency of the peak corresponds to the distance of the object or the wave reflector 2 from the radar 1.

The signal analyzing unit 18 is a block which detects a trespasser or an immersion object into the detection area based upon spectrum data (observed waveform) obtained by the FFT processing unit 17. In the case when neither a trespasser nor an immersion object exists, no peak P1 appears and spectrum data which has continuously appearing peaks P2 is observed. Here, in the case when a trespasser or the like exists, peak P1 appears while, in contrast, the intensity of peak P2 is weakened. In this case, the amount of variations in the peak intensity differs depending on the amount of beams that are blocked by the object. The signal analyzing unit 18 observes the amount of variations in the peak so that determination is made as to whether or not the immersion object is a detection subject.

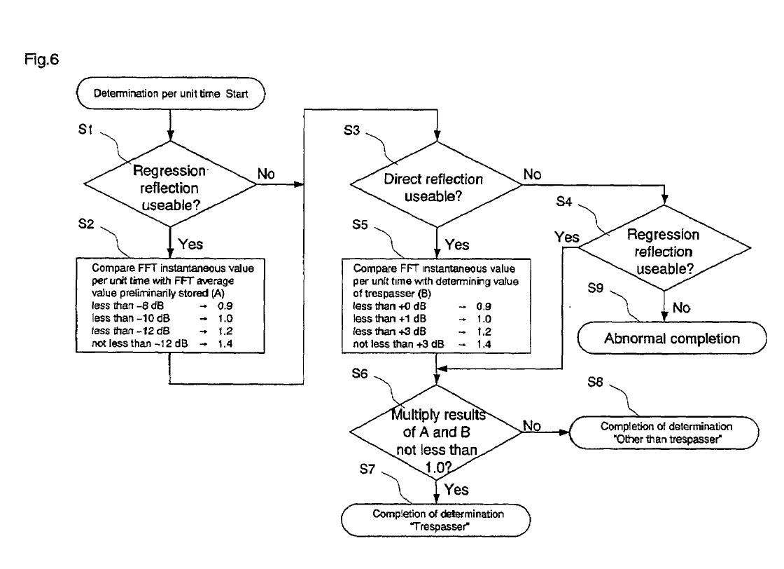

Referring to the flow chart of FIG. 6, the following description will discuss the flow of the determining processes that are carried out by the signal analyzing unit 18. While the immersion object detection device is being operated, the following determining processes are carried out with intervals of a predetermined unit of time.

First, when a determining process is started, determination is made as to whether or not the present device can execute measuring processes of regression reflected waves at step S1. If it is determined that the execution is not available, the determining process based upon the regression reflected waves is skipped. Here, examples in which it is determined that the execution is not available include a situations in which the present device is used as a direct reflection type radar device and other situations where it is not possible to carry out constant observations of the regression reflected waves from the wave reflector 2 due to any factors.

In contrast, in the case when it is determined at step S1 that the process execution is available, a determination process is executed based upon the regression reflected waves at step S2. Here, observations are carried out on the regression reflected waves at predetermined times on a unit time basis, and an averaging process of the resulting spectrum data is carried out so that an FFT instantaneous value per unit time is calculated. In general, the data, instantaneously obtained, has an increase or a decrease due to the state of the object such as shifting state and the direction thereof, and is also susceptible to influences from noise components; therefore, an averaging process is carried out on a plurality of pieces of observed data per unit time so that it is possible to obtain data with a high S/N ratio.

Next, the FFT instantaneous value thus obtained is compared with the FFT average value that has been preliminarily stored in the storing unit such as a memory. This FFT average value is a value that indicates the constant received electric power intensity in the case when no immersion object exists in the detection area.

Here, the radar includes a pulse radar in which a pulse wave is used as a transmission wave and a continuous wave radar in which a frequency modulated wave is used, and the modulation system includes systems such as FM (frequency modulation), AM (amplitude modulation) and PAM (pulse amplitude modulation); however, the present invention is desirably used in any one of these radars, and is not intended to be limited by the FM-CW system shown in FIG. 4. The frequency band of the electric wave to be used is not particularly limited, and myriametric waves or micro waves are desirably used.

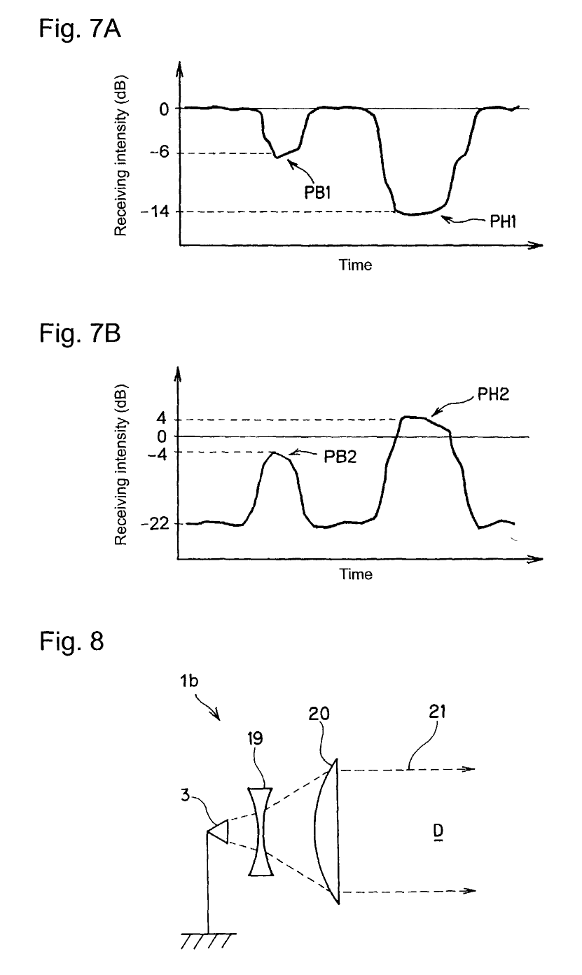

FIG. 7A shows a graph that indicates one example of spectrum data of a regression reflection wave with time being plotted on the axis of abscissa and the intensity of received electric power being plotted on the axis of ordinate. This graph shows the change of the FFT instantaneous value with elapsed time. Here, the received electric power intensity plotted on the axis of ordinate indicates the relative value (differential value) with respect to the FFT average value.

In this graph, in the case when no immersion object exists in the detection area, virtually the same value as the FFT average value is observed as the constant received power intensity. The portion indicated by PB1 shows observed data when a bird crosses the vicinity of the radar 1, while the portion indicated by PH1 shows observed data when a human being crosses the same portion.

In the present embodiment, the beam cross-sectional area of the transmission wave in the vicinity of the radar 1 is made greater than the beam cross-sectional area that can be blocked by a non-detection subject such as a bird. Therefore, even when a bird or the like passes through the detection area in the vicinity of the radar 1, only one portion of the beam is blocked so that the resulting reduction in the intensity of received electric power is maintained in a small level of approximately 6 dB. In contrast, when a human being enters the detection area, the most portion of the beam is blocked so that the intensity of received electric power is reduced by approximately 14 dB.

In this manner, in accordance with the present embodiment, even in the detection area in the vicinity of the radar 1, it is possible to provide a clear difference in the intensity of received power between cases in which a detection subject blocks the beam and in which a non-detection subject blocks the beam. Here, the same results are obtained also in the detection area in the vicinity of the wave reflector 2.

At step S2, a differential value between the FFT instantaneous value and the FFT average value is first calculated. Then, if the differential value is less than −8 dB, 0.9 is substituted for variable A, if it is in a range of not less than −8 dB to less than −10 dB, 1.0 is substituted for variable A, if it is in a range of not less than −10 dB to less than −12 dB, 1.2 is substituted for variable A, and if it is not less than −12 dB, 1.4 is substituted for variable A. For example, in the case of FIG. 7A, with respect to the FFT instantaneous value in the portion of PB1, since the differential value is approximately −6 dB, 0.9 is substituted for variable A. Moreover, with respect to the FFT instantaneous value in the portion of PH1, since the differential value is approximately −14 dB, 1.4 is substituted for variable A.

Next, at step S3, determination is made as to whether or not the present device can execute measuring processes of the direct reflected waves. If it is determined that neither regression reflection nor direct reflection are available at step S3 and S4, the sequence proceeds to step S9 where an error code indicating an abnormal completion is returned, thereby completing the processes.

In contrast, if it is determined at step S3 that the execution is available, determining processes are carried out based upon the direct reflected waves at step S5. Here, observations of the direct reflected waves are first carried out at predetermined times on a unit time basis, and an averaging process is carried out on the resulting spectrum data so that an FFT instantaneous value per unit time is calculated. With respect to the averaging processes, the same processes as those of step S2 are carried out.

Next, the FFT instantaneous value thus obtained is compared with the determining value of a trespasser that has been preliminarily stored in the storing unit such as a memory. This determining value is a value that is set based upon the intensity of received electric power obtained when a detection subject (trespasser) exists within the detection area. Preferably, this value is made sufficiently greater than the intensity of received electric power that can be obtained from a non-detection subject such as an animal or a flying object, and set to a value smaller than the lower limit value that sufficiently ensures the existence of a detection subject. The reason that this value is set to a value smaller than the lower limit value is because, by allowing the determining value to have a certain degree of margin, it becomes possible to prevent a trespasser from being erroneously detected as a non-detection subject. Here, the intensity of received electric power of the direct reflected waves varies in accordance with the distance from the radar 1 to the immersion object; therefore, a plurality of determining values are preliminarily prepared based upon distances, and the determining value to be used at step S3 is preferably selected based upon the peak frequency of the direct reflected waves.

FIG. 7B shows a graph that indicates one example of spectrum data of a direct reflected wave with time being plotted on the axis of abscissa and the intensity of received power being plotted on the axis of ordinate. This graph shows the change of the FFT instantaneous value with elapsed time. Here, the received electric power intensity plotted on the axis of ordinate indicates the relative value (differential value) with respect to the above-mentioned determining value.

In this graph, in the case when no immersion object exists in the detection area, noise of −22 dB is observed as a constant intensity of received electric power. The portion indicated by PB2 shows observed data when a bird crosses the vicinity of the radar 1, while the portion indicated by PH2 shows observed data when a human being crosses the same portion.

In the present embodiment, the beam cross-sectional area of the transmission wave in the vicinity of the radar 1 is made greater than the beam cross-sectional area that can be blocked by a non-detection subject such as a bird. Therefore, even when a bird or the like passes through the detection area in the vicinity of the radar 1, only one portion of the beam is reflected so that the resulting increase in the intensity of received electric power is maintained in a small level of approximately 18 dB, which does not reach a determining value (0 dB in the graph) preliminarily stored (which is smaller than it by approximately 4 dB). In contrast, when a human being enters the detection area, a substantial portion of the beam is reflected so that the intensity of received power is increased by approximately 26 dB, thereby exceeding the above-mentioned determining value.

In this manner, in accordance with the present embodiment, even in the detection area in the vicinity of the radar 1, it is possible to provide a clear difference in the intensity of received electric power between cases in which a detection subject blocks the beam and in which a non-detection subject blocks the beam. Here, the same results are also obtained in the detection area in the vicinity of the wave reflector 2.

At step S5, a differential value between the FFT instantaneous value and the determining value is first calculated. Then, if the differential value is less than +0 dB, 0.9 is substituted for variable. B, if it is in a range of not less than +0 dB to less than +1 dB, 1.0 is substituted for variable B, if it is in a range of not less than +1 dB to less than +3 dB, 1.2 is substituted for variable B, and if it is not less than +3 dB, 1.4 is substituted for variable B. For example, in the case of FIG. 7B, with respect to the FFT instantaneous value in the portion of PB2, since the differential value is approximately −4 dB, 0.9 is substituted for variable B. Moreover, with respect to the FFT instantaneous value in the portion of PH2, since the differential value is approximately +4 dB, 1.4 is substituted for variable B.

Next, at step S6, the resulting values of variable A and variable B are multiplied, and it is determined whether or not the resulting value is not less than 1.0. Here, if only either one of the processes of step S2 and step S5 has been executed, no multiplying process between the variables is carried out, and the above-mentioned determination is made by using only the variable having a substituted value.

Here, in the case when the value is not less than 1.0, it is determined that the observed peak is derived from a detection subject, that is, a trespasser exists. In contrast, when the value is less than 1.0, it is determined that the observed peak is not derived from a detection subject, that is, no trespasser exists.

As described above, in accordance with the present embodiment, even in the vicinity of the radar 1 or in the vicinity of the wave reflector 2, it is possible to clearly identify received electric power derived from a detection subject or received electric power derived from a non-detection subject; therefore, it is possible to determine whether or not any immersion object is a detection subject with high precision.

Moreover, since the determination is made based upon the value obtained by combining the measured results of the regression reflected wave and the measured results of the direct reflected wave, the determining process is less susceptible to influences such as noise, making it possible to improve the reliability of the results of determination and also to reduce erroneous detections.

The following description will discuss another embodiment of the present invention. In the following description, those constituent parts that are the same as those of the first embodiment are indicated by the same reference numerals, and the detailed description thereof is omitted, and the description is focused on featured portions different from those of the first embodiment.

FIG. 8 shows a second embodiment of the present invention. In the first embodiment, the parabolic antenna is used as the transmitter-receiver means; however, in the present embodiment, a lens antenna is used.

As shown in FIG. 8, the transmitter-receiver antenna 1b of the present embodiment is prepared as a lens antenna which is one mode of an opening face antenna, and provided with a primary radiating source 3 for electric waves, and a concave lens 19 and a convex lens 20 that serve as electric wave lenses.

The concave lens 19 and convex lens 20 are dielectric lenses made of a material having a high dielectric property such as ceramics and resin. These are formed into the same shapes as optical lenses. Here, in the case when expansion of electric waves from the primary radiating source 3 is large, it is not necessary to use the concave lens 19.

Upon transmitting an electric wave, a transmission wave 21, which is radiated toward the concave lens 19 from the primary radiating source 3, is expanded by the concave lens 19, refracted by the convex lens 20 into parallel beams, and radiated as a plane wave having an aligned phase on its opening face. This transmission wave 21, which forms a plane wave, has a comparatively sharp directivity, and forms parallel beams that have little expansion.

Since the transmitter-receiver antenna 1b has an aperture area that is greater than a cross-sectional area that can be blocked by a non-detection subject, the transmission wave 21 is already allowed to have a beam width that is sufficiently greater than a bird that is a non-detection subject, in the vicinity of the radar. Therefore, with the arrangement of the present embodiment also, it is possible to obtain the same functions and effects as those of the first embodiment.

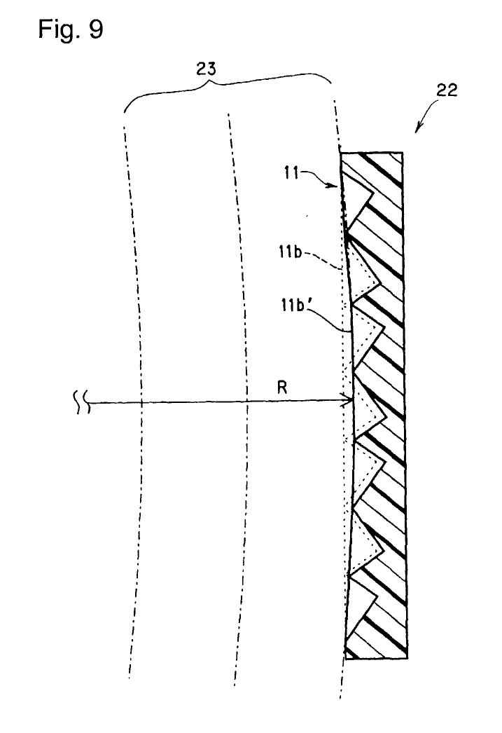

FIG. 9 shows a third embodiment of the present invention. In the case when a frequency of 76 GHz is selected as the frequency of an electric wave to be used for the radar, the corresponding wavelength is 4 mm; therefore, when the fact that the electric wave of the radar carries out a round-trip propagation is taken into consideration, there are points at which electric waves intensify each other at every 2 mm of the line-of-sight straight distance (half of the path difference of the electric waves), and there are points at which the electric waves weaken each other at positions each having an offset of 1 mm from the above-mentioned point. These phenomena are caused by interference of electric waves. Therefore, as indicated by broken lines in the Figure, in the case when the opening faces 11b of the reflectors 11 are aligned on the same plane, the above-mentioned interference in the electric waves sometimes occurs, resulting in degradation in the reflection efficiency.

Therefore, in the present embodiment, the respective reflectors 11 are arranged so as to allow the opening faces 11b′ of the reflectors 11 to be virtually aligned along the same phase face 23 of the electric wave. In other words, the opening faces 11b′ are aligned on the spherical face with a radius of R so that the same distance R is set from the radar to the respective reflectors 11.

Here, it is not necessary to arrange the respective opening faces 11b′ along the above-mentioned spherical face strictly, and in order to prevent the interference of electric waves, deviations of the distance from the radar to the respective reflectors 11 only need to be limited to less than ¼ of the wavelength, that is, less than 1 mm.

In accordance with this structure, in addition to the same functions and effects as those of the first embodiment, it is possible to prevent reflected waves from causing deviations in the phase and interference, and also to improve the reflection efficiency of the reflector 22; thus, it becomes possible to further improve the identifying precision of a non-detection subject in the vicinity of the wave reflector 22.

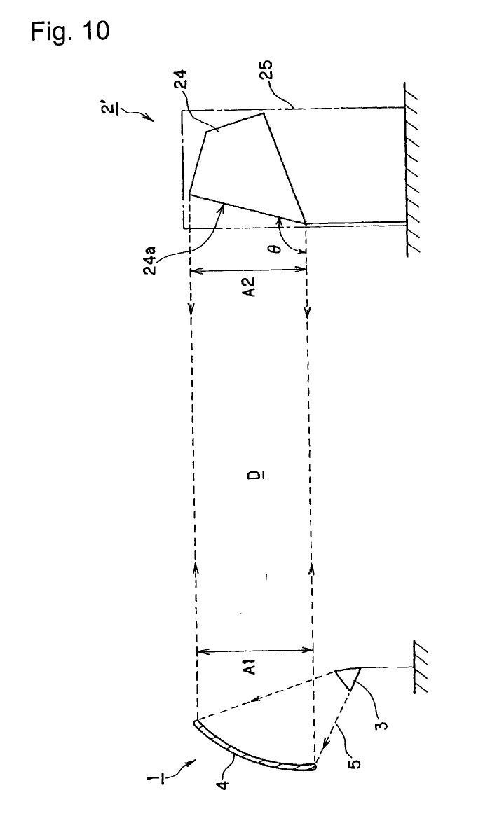

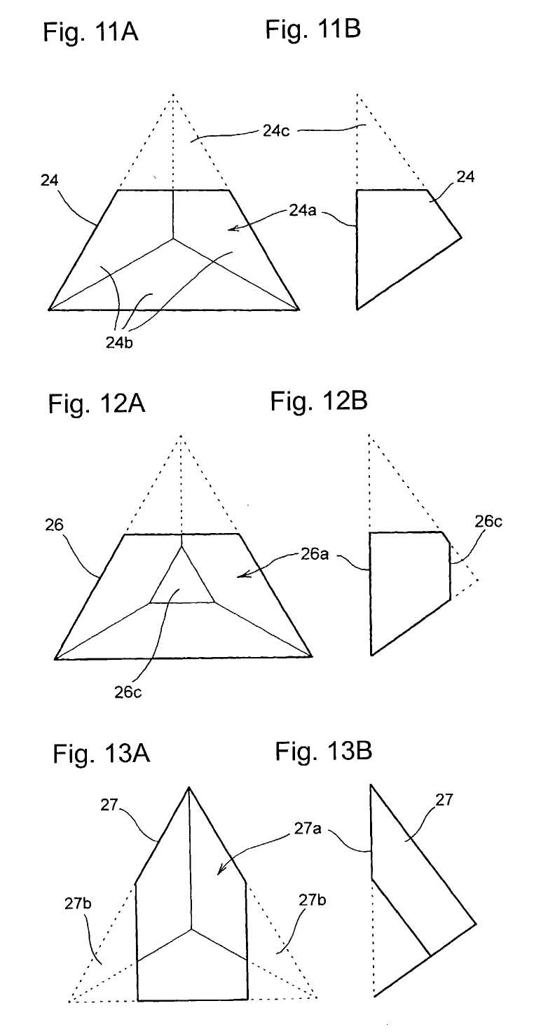

FIGS. 10 and 11 show a fourth embodiment of the present invention. In the first embodiment, a reflector array, constituted by a plurality of small reflectors that are aligned, is adopted; however, in the present embodiment, a single large-size reflector is used to form the wave reflector.

In general, since the reflector makes it possible to provide a reflected electric power that corresponds to its aperture area, it is desirable to form the opening face as big as possible. However, when the reflector is actually used outdoors, the reflector 24 is generally covered with a radome 25 that is formed by a material that easily transmits electric waves so as to protect it from weather variations and stains, as shown in FIG. 10. Here, no limitation is imposed on the size of the radome 25 itself; however, in addition to limitations under the environment in which the device is actually installed, predetermined limitations are imposed on the outer shape of the radome when an attempt is made to easily install it with a reduced wind-receiving area. Consequently, it is necessary to increase the aperture area of the reflector 24 within the limited range.

Therefore, in the present embodiment, the reflector 24 is designed to have the following shape.

As shown in FIG. 10 and FIG. 11 in a combined manner, each reflector 24 has a pyramid shape having reflection 24a on the side faces and an opening face 24a on the bottom face, with one corner portion 24c of the corner portions including the opening face 24a being cut out. In the present embodiment, supposing that the height of the radome 25 is limited due to the limitations in the installation environment, the reflector 24 is designed to have a shape in which the corner portion 24c sticking upward is cut out virtually in the horizontal direction. Moreover, the opening face 24a of the reflector 24 is set to have an aperture area that is greater than a beam cross-sectional area that can be blocked by a non-detection subject. The reflector 24 is constituted by an electric-wave reflecting material such as a metal plate, or formed by coating the surface of a non-metal frame with an electric-wave reflecting material.

When this reflector 24 is installed, it is preferable to install it with the beam axis and the opening face 24a being tilted from each other with a predetermined angle θ. This angle θ refers to an angle that makes the reflecting efficiency of the reflector 24 greatest. The reason that the greatest reflecting efficiency is obtained when the opening face is tilted in this manner is because the shapes of the opening face 24a and the reflecting face 24b are made asymmetric from each other due to the cut-out corner portion 24c. Here, in the case of the shape of the present embodiment, the angle θ made by the beam axis and the opening face 24a of the reflector 24 is set to approximately 102°, the greatest reflecting efficiency is obtained.

In accordance with the above-mentioned structure, under the same height limitation, it is possible to maintain a wider aperture area in the horizontal direction in comparison with the conventional reflector with the opening face having a right triangle shape. In other words, it is possible to miniaturize the outer shape of the reflector, to expand the aperture area of the reflector 24 and also to increase the reflected electric power of the reflector 24, simultaneously. Here, even when the corner portion 24c is cut out, it is possible to maintain the property for reflecting the incident electric wave in a direction virtually opposite to the incident direction thereof

Moreover; since the aperture area of the reflector 24 is made sufficiently greater than the beam cross-sectional area that can be blocked by a non-detection subject, it becomes possible to obtain the same functions and effects as those of the first embodiment.

Furthermore, this structure is formed by using the single reflector 24; therefore, different from the aforementioned reflector array, it is not necessary to prepare methods for preventing phase deviation between reflectors and the interference of electric waves, and it becomes possible to provide very easy manufacturing processes.

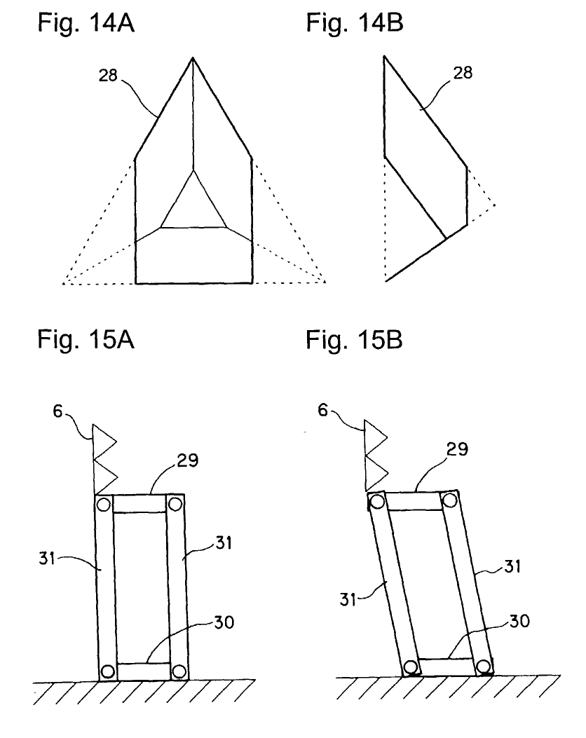

FIGS. 12 to 14 show modified examples of the reflector of the present embodiment. A reflector 26, shown in FIG. 12, has a truncated pyramid shape with a top portion 26c being formed into a plane that is virtually in parallel with the opening face 26a. A reflector 27, shown in FIG. 13, has a pyramid shape with two corner portions 27b including an opening face 27a being cut out. Moreover, a reflector 28, shown in FIG. 14, has a shape obtained by forming the reflector 27 of FIG. 13 into a truncated pyramid shape.

The application of each of these reflectors 26, 27, 28 also makes it possible to obtain the functions and effects similar to those of the reflector 24 of the present embodiment. In particular, the reflectors 24, 26 are desirably applied to a case in which there is a limitation to the installation width in the vertical direction, and the reflectors 27, 28 are desirably applied to a case in which there is a limitation to the installation width in the horizontal direction. Moreover, the application of each of the reflectors 26, 28 that have a truncated pyramid shape makes it possible to miniaturize the size in the depth direction (beam axis direction).

FIG. 15 shows a fifth embodiment of the present invention. As shown in this Figure, a supporting frame (supporting member) of a reflector array 6 is constituted by a fixing portion 29 to which the reflector array 6 is secured, a leg portion 31 for supporting this fixing portion 29 and a bottom portion 30 that is placed on an installation face.

The fixing portion 29 and the leg portion 31 are connected to each other by a pin joint, and these are allowed to rotate relative to each other when an external force of not less than a predetermined strength is applied thereto. Moreover, the leg portion 31 and the bottom portion 30 are also joined to each other by a pin joint. In other words, this supporting frame is provided with a parallel crank mechanism (parallel moving mechanism) which includes the fixing portion 29 serving as a free crank, the bottom portion 30 serving as a fixed crank and the leg portion 31 serving as a link.

With this structure, even when the supporting frame is subjected to any impact from the external environment, such as a collision with an animal or a flying object and influences from wind and rain, the leg portion 31 is allowed to tilt so as to absorb the impact, and the supporting frame is free from a deformation such as bending. Further, even if the leg portion 31 is tilted, the fixing portion 29 and the installation face are maintained in parallel with each other so that the relative angle between the opening face of the reflector array 6 and the beam is always maintained constant; thus, it becomes possible to prevent degradation in the reflected power and received power and degradation in the identifying precision or the like due to an offset of the beam axis.

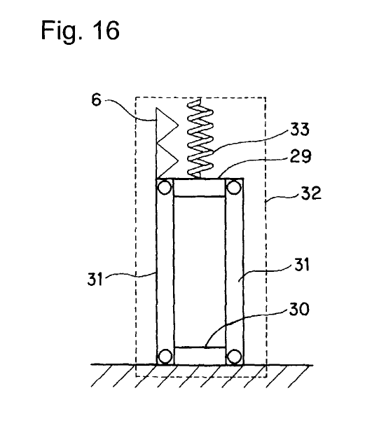

Moreover, as shown in FIG. 16, it is preferable to provide a structure in which one portion of the supporting frame is connected to a radome 32 through an elastic member such as a spring 33. With this structure, the spring 33 functions as an impact absorbing means that alleviates impacts from the external environment, and even when the leg portion 31 is tilted, the inclination of the leg portion 31 is corrected by an elastic restoring force of the spring 33 to allow the reflector array 6 to return to its right position. Thus, it becomes possible to more effectively prevent degradation in the reflected power and received electric power and degradation in the identifying precision or the like.

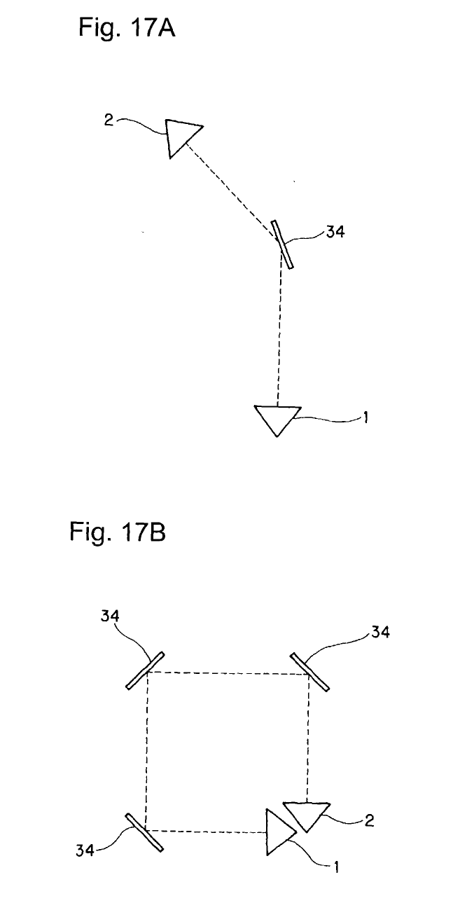

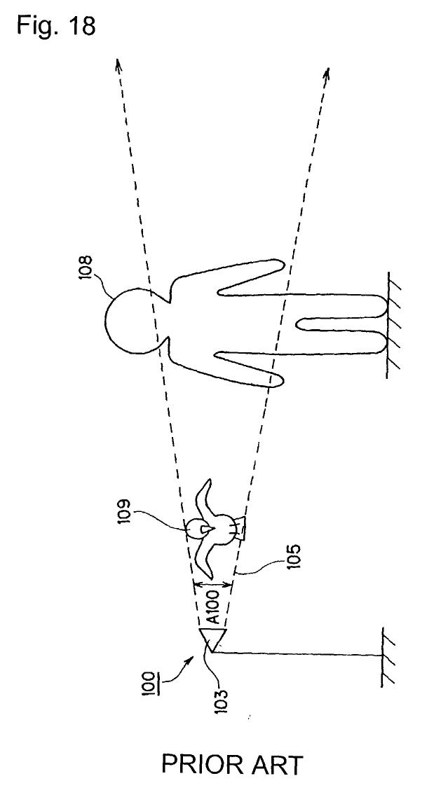

In the above-mentioned first embodiment, the radar 1 and the electric wave reflector 2 are aligned face to face with each other so as to form the detection area D having a straight-line shape; however, the present invention is not intended to be limited by this arrangement. For example, as shown in FIG. 17, a reflector 34, which serves as a bending member for bending the advancing direction of the beam (advancing direction of electric waves), is placed between the radar 1 and the electric wave reflector 2 so that the advancing path of the beam is bent to provide a detection area having, for example, an arrow point shape (FIG. 17A), a U-letter shape or a box shape (FIG. 17B). Moreover, in the present embodiment, a plane reflective plate, which reflects electric waves with a reflection angle that is equal to the incident angle, is used as the reflector 34.

This arrangement makes it possible to provide a detection area having a non-linear shape so that, for example, it becomes possible to easily place a detection area along the entire periphery of a building or a winding place that is difficult to observe entirely. In other words, it becomes possible to carry out an immersion object detection at a plurality of places by using a single radar so that it is possible to improve the utility of the device and also to cut costs in comparison with the radar 1 because only an inexpensive reflector 34 needs to be added thereto.

In the case when an infrared sensor or an optical sensor is used in the same structure, infrared rays and light are susceptible to extreme attenuation due to adhesion of dust and sand grains to the reflector 34, failing to put the device into practical use. However, since the present device uses electric waves that have wavelengths that are much longer than those of the infrared rays and the like, it is less susceptible to attenuation even when dust, sand grains and the like adhere to the reflection face of the reflector 34, making it possible to use the device outdoors for a long time.

As described above, the structure of the present invention makes it possible to improve the identifying precision between the detection subject and non-detection subject, and consequently to reduce the possibility of erroneous detections.

While exemplary embodiments of the invention have been described and illustrated, it should be apparent that many changes and modifications can be made without departing from the spirit or scope of the invention. Accordingly, the invention is not limited by the description above, but is only limited by the scope of the appended claims.

What is claimed as new and desired to be protected by Letters Patent of the United States is:

1. An immersion object detection device comprising:
a radar having a transmitter-receiver means for transmitting and receiving electric waves, and
reflection means which reflects an electric wave transmitted from the radar toward the same radar so that an immersion object entering a detection area formed by electric-wave beams that are carried between the radar and the reflection means is detected,
wherein the beam cross-sectional areas of a transmission wave in the vicinity of the radar and a reflected wave in the vicinity of the reflection means are set to be greater than a beam cross-sectional area that is blocked by a predetermined non-detection subject that is excluded from detection subjects.

2. The immersion object detection device according to claim 1, wherein the beam cross-sectional areas of the transmission wave in the vicinity of the radar and the reflected wave in the vicinity of the reflection means are designed to expand in at least one direction with respect to the greatest beam cross-sectional area that is blocked by the non-detection subject.

3. The immersion object detection device according to claim 1, wherein the transmitter-receiver means is an opening face antenna having an aperture area greater than the beam cross-sectional area that is blocked by the non-detection subject.

4. The immersion object detection device according to claim 1, wherein the reflection means is a reflector array constituted by a plurality of reflectors that are placed with aligned opening faces, and the aperture area of the entire reflector array is set to be greater than the beam cross-sectional area that is blocked by the non-detection subject.

5. The immersion object detection device according to claim 4, wherein the plurality of reflectors are arranged so that the respective opening faces thereof are aligned along the same phase plane of electric waves.

6. The immersion object detection device according to claim 1, wherein the reflection means is a reflector that has an aperture area that is greater than a beam cross-sectional area that is blocked by the non-detection subject.

7. The immersion object detection device according to claim 6, wherein the reflector has a cone shape or a truncated cone shape, with the side face forming a reflection face and the bottom face forming an opening face, with at least one corner portion including the bottom face having a cutout shape.

8. The immersion object detection device according to claim 7, wherein the reflector has a pyramid shape or a truncated pyramid shape with three reflection faces that are respectively orthogonal to each other.

9. The immersion object detection device according to claim 1, wherein a supporting member for supporting the transmitter-receiver means or the reflection means comprises a fixing unit on which the transmitter-receiver means or the reflection means is secured and a parallel moving mechanism which is capable of moving the fixing unit in parallel with the supporting member installation face when the supporting unit is tilted.

10. The immersion object detection device according to claim 9, further comprising a radome that covers the transmitter-receiver means or reflection means and the supporting member, with the supporting member being connected to the radome through an elastic member.

11. The immersion object detection device according to claim 1, wherein a bending member for bending an advancing path of the beam is placed between the radar and the reflection means so that the detection area is set to have a non-straight-line shape.

12. An immersion object detection device comprising:
a radar having a transmitter-receiver means for transmitting and receiving electric waves so that an immersion object is detected by receiving reflected waves from the immersion object,
wherein the beam cross-sectional area of a transmission wave in the vicinity of the radar is set to be greater than a beam cross-sectional area that is blocked by a predetermined non-detection subject that is excluded from detection subjects.

13. The immersion object detection device according to claim 12, wherein the transmitter-receiver means is an opening face antenna having an aperture area greater than the beam cross-sectional area that is blocked by the non-detection subject.

14. An electric wave reflector, which reflects an electric wave that has been made incident thereon in a direction virtually opposite to the incident direction, comprising:
a reflector array constituted by a plurality of reflectors that are placed with aligned opening faces.

15. The electric wave reflector according to claim 14, wherein the reflectors are arranged so that the respective opening faces thereof are aligned along the same phase plane of electric waves.

16. An electric wave reflector, which reflects an electric wave that has been made incident thereon in a direction virtually opposite to the incident direction, comprising:
a reflector which has a cone shape or a truncated cone shape, with the side face forming a reflection face and the bottom face forming an opening face, with at least one corner portion including the bottom face having a cutout shape.

17. The electric wave reflector according to claim 16, wherein the reflector has a pyramid shape or a truncated pyramid shape with three reflection faces that are respectively orthogonal to each other.
